(19) United States
(12) Patent Application Publication
(10) Pub. No.: US 2020/0102085 A1
(43) Pub. Date: Apr. 2, 2020

(54) Device For Reducing Or Even Eliminating Tonal Noise For An Aircraft Powerplant De-Icing System

(71) Applicant: Airbus Operations S.A.S., Toulouse (FR)

(72) Inventors: Thierry Fargier, Tournefeuille (FR); Franck Le-Flem, Lagraulet Saint Nicolas (FR)

(73) Assignee: Airbus Operations S.A.S., Toulouse (FR)

(21) Appl. No.: 16/583,513

(22) Filed: Sep. 26, 2019

(30) Foreign Application Priority Data
Sep. 28, 2018 (FR) 18 59021

(51) Int. Cl. B64D 33/02; B64D 15/04

(52) U.S. Cl. CPC B64D 33/02; B64D 15/04; B64D 2033/0233; B64D 2033/0206; B64C 2230/14

(57) ABSTRACT

A device for an aircraft powerplant de-icing system making it possible to reduce or eliminate a tonal noise generated by a flow of air along a surface having an orifice opening into a cavity extending on the side opposite this surface, the orifice having a downstream edge relative to the direction of flow of the air, includes a deflector positioned next to the downstream edge, extending towards the inside of the cavity, and oriented perpendicularly to the direction of flow of the air to divert towards the outside of the orifice vortices formed in the shear layer due to the flow of the air along the surface over each orifice. The deflector at the downstream edge of each exhaust orifice of the de-icing system makes it possible to redirect the vortices outside the cavity while preventing them from being greatly deformed when they pass over the downstream edge.

### FIELD OF THE INVENTION

The invention relates to aircraft powerplants and more particularly to a de-icing system installed in the lip of a powerplant nacelle.

### BACKGROUND OF THE INVENTION

Commercial aircraft have powerplants that are usually suspended underneath the wing or fixed on a rear fuselage portion. These powerplants generally have an engine located inside a nacelle fixed to the aircraft wing or fuselage by a support strut one end of which is connected to the outer wall of the nacelle and the other end of which is connected to the wing or fuselage. The axial positions of the different components of the powerplant are hereafter given relative to the direction of the air flow passing through it.

On the front portion of the nacelle is an air intake that opens into an inner duct formed by an inner wall of the nacelle. The inner duct channels the air towards the engine, which can be a turboprop, for example. The air intake is provided with a lip, the inner edge of which meets the inner duct and the outer edge of which meets the outer wall of the nacelle. This lip has an aerodynamic function that consists of capturing the air without generating separations, as these are detrimental to the service life of the fan blades.

During the flight phases, frost or ice can form on the engine air intake. A build-up of ice upstream of the engine can detract considerably from the powerplant performance, and in extreme cases pieces of ice can detach and be sucked into the inner duct and damage the engine, which requires additional maintenance operations. To prevent the formation of frost or ice, a de-icing system is located in the lip.

In general, the air intake is a specific part of the powerplant that ends downstream in a rear frame stiffening the structure. At the other end of the air intake is a peripheral channel having a D-shaped cross-section, more commonly known as the D-duct. The front portion of the D-duct is formed by the lip and the rear portion is formed by a front frame that closes the dish formed on the rear of the lip. Hot air conveyed from the engine by a de-icing line circulates in the D-duct, thus preventing the formation of frost. This pneumatic de-icing system is currently used in the nacelle de-icing systems also commonly known as Nacelle Anti-Ice, or NAI, systems. Pneumatic NAI systems have exhaust orifices allowing the pressurized hot air in the D-duct to be exhausted to the outside and a regulation system controlling the injection of hot air into the D-duct. The NAI system can be in active mode when the flight conditions require de-icing of the powerplant air intake lips or in inactive mode when they do not.

When the de-icing system is in inactive mode, a tonal noise or whistling can occur, which can increase the certified noise level of the aircraft and can also cause noise annoyance, in the form of whistling, that can be heard up to several tens of kilometers from the airport, in particular during the approach phase before landing.

This whistling is the result of the coupling of an exciter-resonator system. When the NAI system is in inactive mode, the D-duct behaves like a cavity that communicates with the outside through the exhaust orifices only. The flow of the air passing over the exhaust orifices produces, due to shear, vortices that tend to be deformed when they meet the downstream edge of these exhaust orifices. The deformation speed of these vortex structures generates noise. This noise can become tonal if a retroactive loop is established between the emission of the noise and the shedding of the vortices. This retroactive loop is the result of the use of the acoustic energy emitted on deformation of the vortices on the downstream edge of the orifices to act on the shed vortices generated from the upstream edge and give them rhythm. This tonal noise, known as the exciter, can then excite a cavity mode of the D-duct that then imposes its so-called resonance frequency, with an amplifying effect, known as the resonator. The frequency and intensity of this whistling depends on the geometry of the exhaust orifices, the cavity modes of the D-duct and the local flow conditions of the air at the exhaust orifices.

### BRIEF SUMMARY OF THE INVENTION

Aspects of the invention may reduce, or even eliminate, the exciter tonal noise generated at each exhaust orifice communicating with the cavity formed by the D-duct when the NAI system is inactive.

An embodiment of the invention includes an aircraft powerplant de-icing system, located in a lip surrounding an air intake of a powerplant, said lip extending between an outer wall of a nacelle of the powerplant and an inner duct channeling the air towards a fan arranged downstream of the powerplant air intake, said system including: a peripheral channel made up of a cavity formed in said lip, arranged around the inner duct of the powerplant and suitable for ensuring the circulation around the air intake of a flow of hot gas that is injected into it; at least one orifice formed on a side wall of said channel and through which said flow of pressurized hot gas is exhausted from it towards the air flowing along the outer wall or the inner duct of the powerplant.

The de-icing system also comprises a deflector positioned next to a downstream edge of the orifice relative to the direction of flow of the air. The deflector extends towards the inside of the channel, being oriented perpendicularly to the general direction of flow of the air and forming an angle relative to said side wall of the channel along which the air flows, in order to divert towards the outside of said orifice vortices formed in the shear layer of the air over each orifice.

The installation of a deflector at the downstream edge of each orifice makes it possible to redirect the vortices outside the cavity while preventing them from being greatly deformed when they pass over the downstream edge. Thus, the noise generated by the deformation of the vortices when they pass over the downstream edge is eliminated or at least greatly reduced. Thus, the retroactive loop between the two edges of the orifice can only be established with difficulty to produce a tonal noise capable of exciting a cavity mode of the D-duct when the NAI system is inactive. In addition, the cavity of the D-duct will not be able to resonate or at least will resonate with a greatly reduced sound level.

Advantageously, the angle and height of said deflector relative to said side wall of the channel are defined to minimize the deformation of the vortices when they meet the downstream edge, and the shut-off effect of said orifice.

Thus, the geometric features of said deflector reduce the occurrence of a loss of hot air flow rate when the de-icing system is active, which can affect the effectiveness of the de-icing system.

Preferably, the height of the deflector is greater than or equal to the diameter of the largest vortices when measured perpendicularly to the general direction of flow of the air.

Preferably, the angle formed by the deflector with said side wall of the channel has a value of between 0° and 90°, preferably 45°.

In a particularly advantageous configuration, the deflector surrounds the orifice over one third to one half of its circumference.

Preferably, the deflector has a curved shape corresponding to the shape of the portion of the orifice that it surrounds and/or has a reinforcement formed at its base.

Advantageously, the deflector is riveted and bonded directly onto an inner surface of the side wall of the peripheral channel through which the orifice is formed.

Preferably, several deflectors are formed on a plate mounted in relation to a group of several orifices.

Advantageously, the orifice(s) is/are generally situated on the outer wall and/or on the outer portion of the lip of the powerplant.

A second aspect of the invention relates to an aircraft powerplant comprising an engine located in a nacelle that has an air intake provided with a lip extending between an outer wall and an inner wall of the nacelle. The inner wall forms an inner duct channeling the air towards the engine arranged downstream of the air intake. The powerplant also comprises a de-icing system as defined above.

A third aspect of the invention relates to an aircraft comprising at least one powerplant as defined above.

### BRIEF DESCRIPTION OF THE DRAWINGS

Further features and advantages of the invention are highlighted by the following description of non-limitative examples of embodiments of the different aspects of the invention. The description refers to the attached drawings, which are also given by way of non-limitative examples of embodiments of the invention:

FIG. 1 shows a perspective view of a turboprop type powerplant;

FIG. 2 shows a detailed cross-sectional view of the air intake of the powerplant;

FIG. 3 shows a diagrammatic view of the formation of the vortices over the orifices and the treatment thereof to prevent or at least significantly reduce the generation of a tonal noise;

FIG. 4 shows a detailed cross-sectional perspective view of a deflector according to the invention;

FIG. 5 shows a perspective view of a variant of the invention in which the deflectors are grouped together on a plate; and

FIG. 6 shows an aircraft provided with powerplants according to the invention.

### DETAILED DESCRIPTION

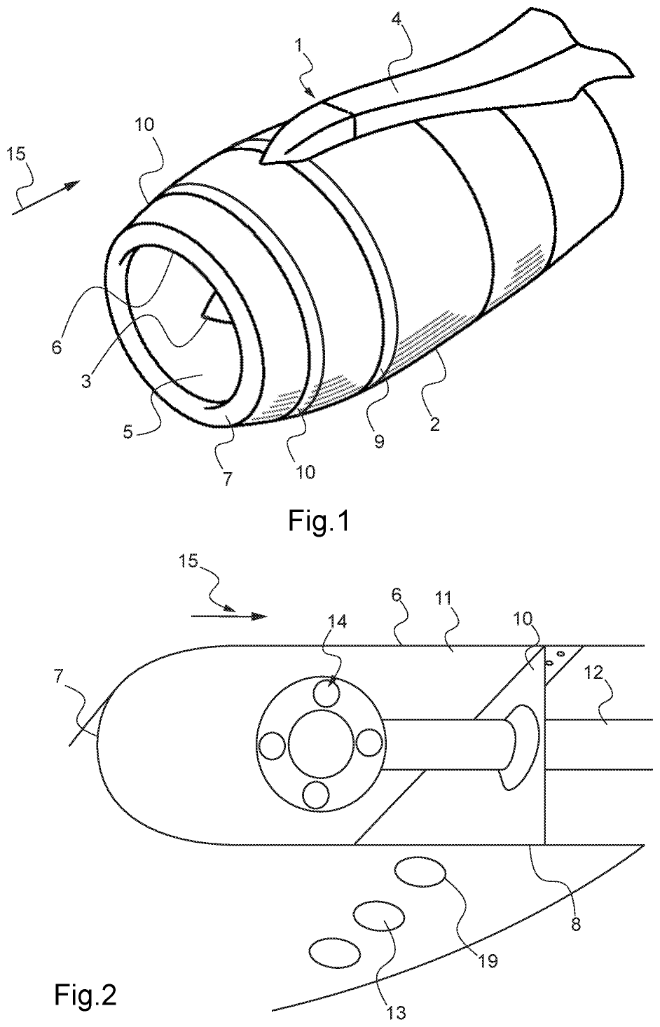

FIG. 1 shows an aircraft powerplant of the turboprop type. The relative axial positions of the components of the powerplant 1 and the different systems and devices described will hereafter be given relative to the general direction 15 of the air flowing through the powerplant 1 and along the outer surfaces thereof.

This type of powerplant for commercial aircraft typically includes a nacelle 2 in which an engine 3 is located. The nacelle 2 is generally suspended underneath the wing or fixed on a rear fuselage portion by a support strut 4.

On the front portion of the nacelle 2 is an air intake 6 that opens into an inner duct 5 formed by an inner wall of the nacelle surrounding the engine 3. The inner duct 5 channels the air towards the engine 3. The air intake 6 is provided with a lip 7, the inner edge of which meets the inner duct 6 and the outer edge of which meets an outer wall 8 of the nacelle. This lip 7 has an aerodynamic function that consists of capturing the air without generating separations, as these are detrimental to the service life of the fan blades.

During the flight phases, frost or ice can form on the air intake 6. A build-up of ice upstream of the engine 3 can detract considerably from the performance of the powerplant 1, and in extreme cases pieces of ice can detach, be sucked into the inner duct 5 and damage the components of the engine such as blades of a fan of the engine 3. To prevent the formation of frost or ice on commercial aircraft, a de-icing system is located in the lip 7.

Generally, as shown in FIG. 2, the air intake 6 at the front of the nacelle 2 includes, at its downstream end, a rear frame 9 stiffening the structure. At its upstream end the air intake has an annular peripheral channel having a D-shaped cross-section, commonly known as the D-duct 11. The front portion of the D-duct 11 is formed by the lip 7 and the rear portion is formed by a front frame 10 positioned upstream of the rear stiffening frame 9. The front frame 10 shuts off the rear of the dish formed inside the lip 7. The lip is usually made up of several aluminum segments connected together by fishplates. The lip 7 is de-iced, when necessary, by a pneumatic de-icing system also known as a Nacelle Anti-Ice or NAI system. In a pneumatic NAI system, hot air, which is taken from the upper compression stages of the engine 3, is conveyed by de-icing lines 12 into the D-duct 11, where it is injected by nozzles 14 to prevent the formation of frost. Valves are installed on the de-icing lines 12 to regulate the inlet of hot gas into the NAI, in particular in terms of pressure and flow rate. Pneumatic NAI systems have orifices 13 allowing the pressurized hot air in the D-duct 11 to be exhausted to the outside. These exhaust orifices 13 are generally situated on the outer wall 8 and/or on the outer portion of the lip 7 of the nacelle 2 of the powerplant 1 so that when the de-icing system is active, the hot air exiting from the orifices 13 is not captured by the air intake of the powerplant 1 and does not therefore affect the quality of the flow captured in this way by adding local distortion and temperature gradients. The NAI system can be in active mode when the flight conditions require de-icing of the powerplant lips or in inactive mode when they do not.

In inactive mode, the valves controlling the flow rate and pressure of the hot fluid in the D-duct 11 close off the hot gas inlet. As a result, in this mode and in the absence of the overpressure generated by the exhausting of the hot gas, the D-duct 11 behaves like a cavity into which the orifices 13 open and a tonal noise can occur and have a negative impact on the certified noise levels of the aircraft. This tonal noise can cause noise annoyance audible up to tens of kilometers from the airport, in particular during the approach phase preceding landing. An analysis of the turbulence present in the flow of the air at the orifices 13 shows vortices shed over the orifices that then strike the downstream edge 19 of the orifices before dissipating mainly in the D-duct.

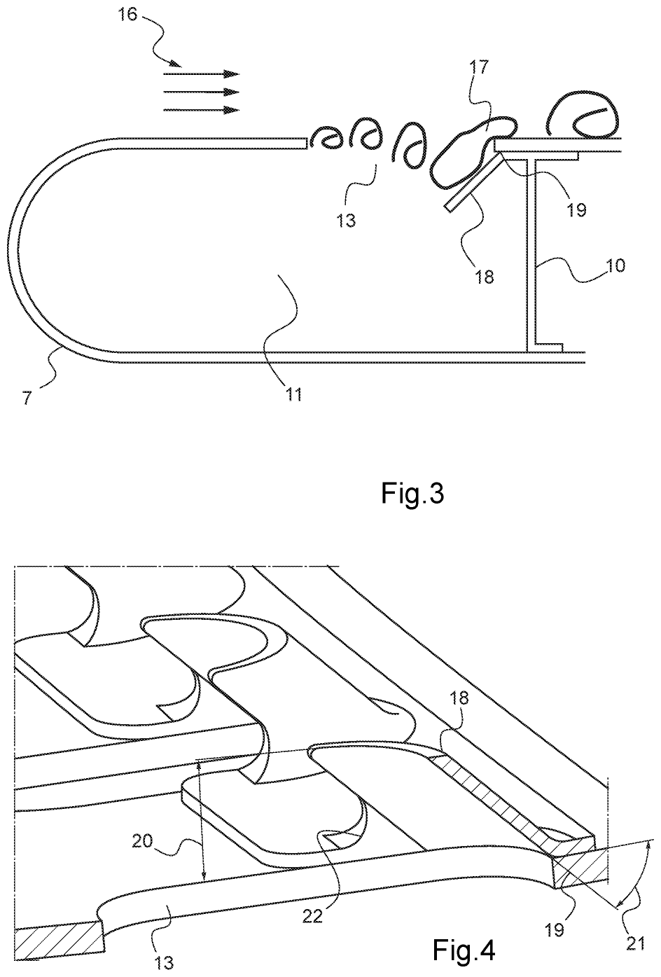

As shown in FIG. 3, the air flow 16 flowing along the surface onto which the orifices 13 open generates vortices 17 over these orifices 13. These vortices 17 grow due to the shear effect and partially or fully enter the cavity formed by the D-duct 11. A deflector 18 is positioned on the downstream edge 19 of each orifice 13 and is oriented so that it systematically diverts the vortices 17 outside the D-duct 11 while minimizing the deformation thereof. This has the effect of generating little or no noise when they pass over the downstream edge 19. A retroactive loop thus cannot be established or is established with difficulty, which prevents the production of the tonal noise capable of exciting a cavity mode of the D-duct or at least reduces the intensity of the resulting cavity resonance. In the case of an NAI system, the deflector 18 is placed inside the D-duct 11 formed in the lip 7. The angle and height of the deflector must be suitable for diverting the vortices 17 outside the D-duct 11 while minimizing the deformation thereof as they pass over the downstream edge 19 of the orifices 13. The vortices grow in the shear layer formed by the flow of air 16 until they reach the downstream edge 19. These vortices must be prevented from meeting an edge that is sharp or thin compared to the size of the vortices in order not to promote rapid deformation of these vortices, which is responsible for increased sound emission in this case.

FIG. 4 illustrates an embodiment of the deflector 18. For an orifice with a 30 mm diameter, the vortices reach a size of approximately 6 mm, which requires a deflector height 20 at least equal to the size of the largest vortices when measured in the direction normal to the wall of the D-duct 11 in which the orifice 13 is formed. An angle 21 formed by the deflector relative to said wall of the D-duct is fixed at 45°. This angle 21 of the deflector 18 can have values of between 0° and 90° depending on the benefit sought between minimizing the deformation of the vortices as they pass over the downstream edge 19, by selecting an angle smaller than 45°, and minimizing the pressure drop on passing through the orifice 13 when the hot air of the de-icing system is discharged through it, by selecting an angle larger than 45°. The shape of the deflector 18 must surround the opening of the orifice sufficiently in order to cover all scenarios of local incidence of the flow. For example, the deflector 18 can surround the orifice 13 over more or less ⅓ to ½ of the circumference thereof. This results in a curved shape of the deflector. In addition, an arc-shaped reinforcement 22 is formed at the base of the fins of the deflector surrounding the lateral portions of the orifices 13 in order to guide the vortices towards the ramp formed by the deflector 18. The reinforcement 22 can also have a function of stiffening the assembly. Other shapes are possible for this reinforcement provided that the function of guiding the vortices towards the ramp formed by the deflector is performed. This reinforcement 22 can also be omitted if the guiding of the vortices or mechanical reinforcement is not found to be necessary.

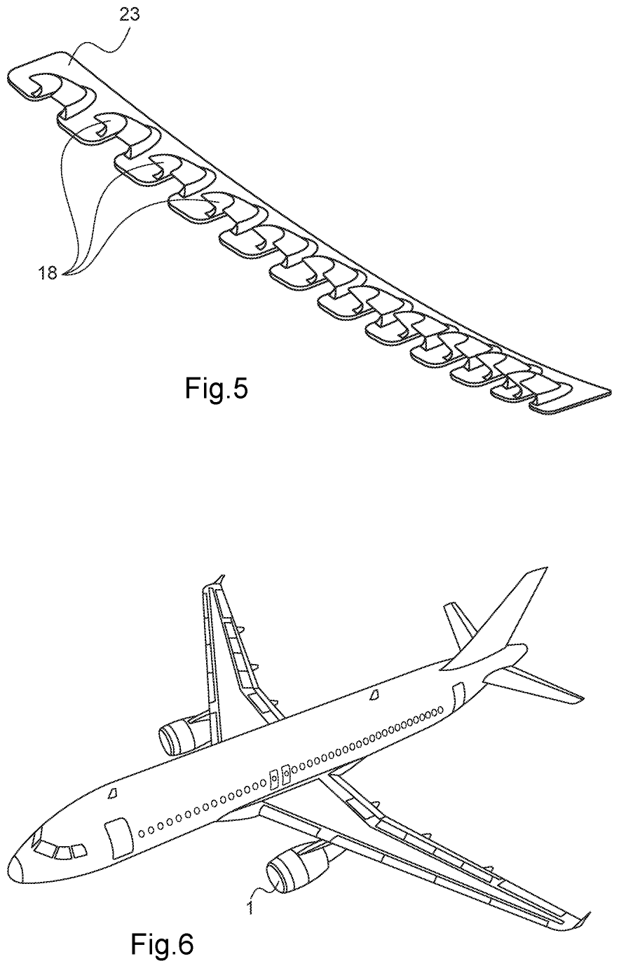

The deflector 18 is riveted and bonded directly onto the wall of the lip 7. Alternatively, the deflector can be obtained by stamping the metal sheet forming the lip, for example during the formation of the orifices 13 surrounded by the deflectors 18. As shown in FIG. 5, several deflectors 18 can be formed, for example by stamping, on a plate 23 that is mounted, for example by riveting and bonding, in relation to a group of orifices 13 so that each deflector 18 is positioned as stated above relative to the downstream edge 19 of its respective orifice 13. This configuration facilitates the mounting of the deflectors.

FIG. 6 shows an aircraft provided with powerplants (1) having an NAI system comprising deflectors according to the invention as described above.

The combination of the advantages obtained by the different aspects of the invention described above makes it possible to significantly reduce the generation of the tonal noise to the extent that it is eliminated in the best case.

As stated in the description above, the different features of the invention and in particular of the deflector can be implemented individually or in any combination according to the context, and in variant configurations different from those described above.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft powerplant de-icing system, located in a lip surrounding an air intake of a powerplant, said lip extending between an outer wall of a nacelle of the powerplant and an inner duct channeling the air towards a fan arranged downstream of the air intake of the powerplant, said de-icing system comprising:
a peripheral channel made up of a cavity formed in said lip, arranged around the inner duct of the powerplant and configured for ensuring the circulation around the air intake of a flow of hot gas that is injected into the peripheral channel;
at least one orifice formed on a side wall of said peripheral channel and through which said flow of pressurized hot gas is exhausted from towards air flowing along the outer wall or the inner duct of the powerplant;
a deflector positioned next to a downstream edge of the at least one orifice relative to the direction of flow of the air; said deflector extending towards inside of the channel, and oriented perpendicularly to the general direction of flow of the air and forming an angle relative to said side wall of the channel along which the air flows, to divert towards outside of said at least one orifice vortices formed in the shear layer of the air over each of the at least one orifice.

2. The aircraft powerplant de-icing system according to claim 1, wherein the angle and height of said deflector relative to said side wall of the channel are defined to minimize the deformation of the vortices when the vortices meet the downstream edge, and the shut-off effect of said at least one orifice.

3. The aircraft powerplant de-icing system according to claim 2, wherein the height of said deflector is greater than or equal to the diameter of the largest vortices when measured perpendicularly to the general direction of flow of the air.

4. The aircraft powerplant de-icing system according to claim 2, wherein the angle formed by said deflector with said side wall of the channel has a value of between 0° and 90°.

5. The aircraft powerplant de-icing system according to claim 1, wherein the deflector surrounds said at least one orifice over one third to one half of a circumference of said at least one orifice.

6. The aircraft powerplant de-icing system according to claim 1, wherein the deflector has a curved shape corresponding to the shape of the portion of the at least one orifice that the deflector surrounds and/or has a reinforcement formed at a base of the deflector.

7. The aircraft powerplant de-icing system according to claim 1, wherein said deflector is riveted and bonded directly onto an inner surface of the side wall of the peripheral channel through which the at least one orifice is formed.

8. The aircraft powerplant de-icing system according to claim 1, wherein the deflector comprises several deflectors formed on a plate mounted in relation to a group of several orifices of the at least one orifice.

9. The aircraft powerplant de-icing system according to claim 1, wherein the at least one orifice(s) is/are generally situated on the outer wall and/or on the outer portion of the lip of the powerplant.

10. An aircraft powerplant comprising:
an engine located in a nacelle;
said nacelle having an air intake provided with a lip extending between an outer wall and an inner wall of the nacelle,
said inner wall forming an inner duct channeling the air towards the engine arranged downstream of the air intake,
wherein the powerplant comprises a de-icing system as defined in claim 1.

11. The aircraft comprising at least one powerplant as defined in claim 10.
